(19) United States
(12) Patent Application Publication
(10) Pub. No.: US 2023/0216630 A1
(43) Pub. Date: Jul. 6, 2023

(54) METHOD AND APPARATUS FOR TRANSMITTING POSITION REFERENCE SIGNAL, COMMUNICATION DEVICE AND STORAGE MEDIUM

(71) Applicant: Beijing Xiaomi Mobile Software Co., Ltd., Beijing (CN)

(72) Inventor: Yang LIU, Beijing (CN)

(73) Assignee: Beijing Xiaomi Mobile Software Co., Ltd., Beijing (CN)

(21) Appl. No.: 18/000,785

(22) PCT Filed: Jun. 5, 2020
(86) PCT No.: PCT/CN2020/094732

§ 371 Date: Dec. 5, 2022

(51) Int. Cl. H04L 5/00

(52) U.S. Cl. CPC H04L 5/0048; H04W 64/00

(57) ABSTRACT

Embodiments of the present disclosure provide a method and an apparatus for transmitting a Position Reference Signal (PRS), and an electronic device and a storage medium. The method for receiving the position reference signal can include sending different parts of the PRS on different symbols according to a bandwidth supported by a UE of a predetermined type.

### TECHNICAL FIELD

Embodiments of the present disclosure relate to, but not limited to a field of wireless communication, and more particularly, to a method and an apparatus for transmitting a Position Reference Signal (PRS), an electronic device and a storage medium.

### BACKGROUND

Currently, the 3rd Generation Partnership Project (3GPP) has carried out project research on Reduced Capability NR devices (Redcap) with communication protocol version (Release, R) R17, which aims to reduce complexity of UE and save cost of the UE while coexisting with R15 or R16 terminal.

PRS is a downlink signal sent by an upper base station, and may be used for UE positioning. However, a bandwidth which is adapted to the sending of the PRS and supported by Redcap UE is challenged with a proposal of the Redcap UE.

### SUMMARY

Embodiments of the present disclosure provide a method and an apparatus for transmitting a position reference signal (PRS), an electronic device and a storage medium.

A first aspect of the embodiments of the present disclosure provide method for sending a position reference signal PRS, the method includes:

sending different parts of the PRS on different symbols according to a bandwidth supported by a UE of a predetermined type.

A second aspect of the embodiments of the present disclosure provide a method for receiving a position reference signal PRS, the method includes:

receiving different parts of the PRS on different symbols, wherein the different parts of the PRS are sent on the different symbols according to a bandwidth supported by a UE of a predetermined type;

demodulating the PRS after combining the different parts of the PRS. receiving method of position reference signal PRS.

A third aspect of the embodiments of the present disclosure provide an apparatus for sending a position reference signal PRS, the apparatus includes:

a sending module, configured to different parts of the PRS on different symbols according to a bandwidth supported by a UE of a predetermined type.

A fourth aspect of the embodiments of the present disclosure provide an apparatus for receiving a position reference signal PRS, the apparatus includes:

a receiving module, configured to different parts of the PRS on different symbols, wherein the different parts of the PRS are sent on different symbols, and are determined according to a bandwidth supported by a UE of a predetermined type;

a demodulation module, configured to demodulate the PRS after combining the different parts of the PRS.

A fifth aspect of the embodiments of the present disclosure provide a communication device including a processor, a transceiver, a memory and an executable program stored on the memory and capable of being run by the processor, wherein the processor executes the method provided in the above first aspect and/or the second aspect when running the executable program.

A sixth aspect of the embodiments of the present disclosure provide a computer storage medium having an executable program stored thereon, which when executed by a processor, causes the method provided in the above first aspect and/or the second aspect to be implemented.

According to technical solutions provided in the embodiments of the present disclosure, the PRS is divided into different parts and is sent on different symbols according to a bandwidth supported by a UE of a predetermined type. In this way, even the UE of the preset type supporting a relatively small bandwidth may successfully receive the PRS, the UEs of different types may successfully receive the PRS, so that the UE may successfully complete the positioning measurement according to the received PRS. If the base station sends the PRS in this way, both the UE of the predetermined type and the UE of the non-predetermined type may use the same sending manner, so as to simplify the manner for the base station to send the PRS.

### BRIEF DESCRIPTION OF THE DRAWINGS

The appended drawings herein are incorporated into the specification and form a part of the specification, showing conformity with embodiments of the present disclosure and used together with the specification to explain principles of embodiments of the present disclosure.

FIG. 1 is a structural diagram showing a wireless communication system according to an exemplary embodiment;

FIG. 2 is a flow diagram showing a method for sending a PRS according to an exemplary embodiment;

FIG. 3A is a schematic diagram showing occupation of resource sent by a PRS according to an exemplary embodiment;

FIG. 3B is a schematic diagram showing occupation of resource sent by a PRS according to an exemplary embodiment;

FIG. 4 is a flow diagram showing a method for receiving a PRS according to an exemplary embodiment;

FIG. 5 is a structural diagram showing an apparatus for processing information according to an exemplary embodiment;

FIG. 6 is a structural diagram showing an apparatus for processing information according to an exemplary embodiment;

FIG. 7 is a structural diagram showing a UE according to an exemplary embodiment;

FIG. 8 is a structural diagram showing a base station according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are apparatuses and methods consistent with aspects related to the present disclosure as recited in the appended claims.

Terms used in the present disclosure are only adopted for the purpose of describing specific embodiments and not intended to limit the present disclosure. “a/an” and “the” in a singular form in the present disclosure and the appended claims are also intended to include a plural form, unless other meanings are clearly denoted throughout the present disclosure. It should also be understood that term “and/or” used in the present disclosure refers to and includes one or any or all possible combinations of multiple associated items that are listed.

It should be noted that, although terms like “first”, “second”, and “third” may be used in the present disclosure to describe a variety of information, the information should not be limited thereto. Those terms are used merely for distinguishing information of the same type from each other. For example, a first information may also be referred to as a second information without departing from scope of the present disclosure. Similarly, the second information may also be referred to as the first information. The word “if” used herein may be understood as “at the time of” or “when” or “in response to determination of” depending on the context thereof.

In order to better describe any embodiment of the disclosure, the embodiments of the disclosure take an application scenario of an intelligent ammeter control system as an example for illustrative description.

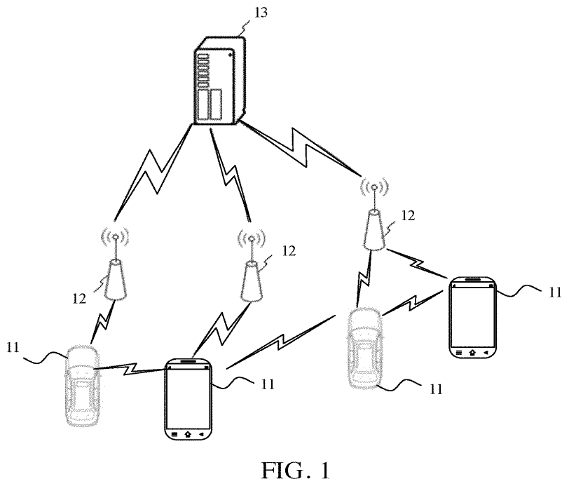

Referring to FIG. 1, FIG. 1 illustrates a structural diagram showing a wireless communication system according to an embodiment. As shown in FIG. 1, a wireless communication system is a communication system based on cellular mobile communication technology, and the wireless communication system may include: several terminals 110 and several base stations 120.

The terminal 110 may be a device that provides voice and/or data connectivity to the user. The terminal 110 may communicate with one or more core networks via a radio access network (RAN). The terminal 110 may be an Internet of Things terminal, such as a sensor device, a mobile phone (or “cellular” phone), and a computer with the Internet of Things terminal, for example, it may be a fixed, portable, pocket-sized, handheld, built-in computer or vehicle-mounted device. For example, Station (STA), subscriber unit, subscriber station, mobile station, mobile, remote station, access point, remote terminal, access terminal, user terminal, user agent, user device, or user equipment (UE). Alternatively, the terminal 110 may also be a device of an unmanned aerial vehicle. Alternatively, the terminal 110 may also be a vehicle-mounted device, and for example, it may be a driving computer with a wireless communication function or a wireless terminal connected to a driving computer. Alternatively, the terminal 110 may also be a roadside device, for example, it may be a street lamp, a signal lamp or other roadside devices with a wireless communication function.

The base station 120 may be a network side device in a wireless communication system. The wireless communication system may be the 4th generation mobile communication (4G) system, also known as the Long-Term Evolution (LTE) system; or, the wireless communication system may also be a SG system, also known as the new radio (NR) system. Alternatively, the wireless communication system may also be the next-generation system of the 5G system. An access network in the 5G system may be called a New Generation-Radio Access Network (NG-RAN).

The base station 120 may be an evolved base station (eNB) used in a 4G system. Alternatively, the base station 120 may also be a base station (gNB) adopting a centralized and distributed architecture in the 5G system. When the base station 120 adopts a centralized and distributed architecture, it usually includes a centralized unit (CU) and at least two distributed units (DUs). The centralized unit is provided with protocol stacks of a packet data convergence protocol (PDCP) layer, a radio link layer control protocol (RLC) layer, and a media access control (MAC) layer. A distribution unit is provided with a physical (PHY) layer protocol stack, and the embodiments of the present disclosure do not limit the specific implementation manner of the base station 120.

A wireless connection can be established between the base station 120 and the terminal 110 through a wireless air interface. In different embodiments, the wireless air interface is a wireless air interface based on the fourth-generation mobile communication network technology (4G) standard; or, the wireless air interface is a wireless air interface based on the fifth-generation mobile communication network technology (5G) standard, for example, the wireless air interface is a new radio (NR); or, the wireless air interface may also be a wireless air interface based on next-generation mobile communication network technology standards based on 5G.

In some embodiments, an End to End (E2E) connection may also be established between the terminals 110, for example, scenarios such as Vehicle to Vehicle (V2V) communication, Vehicle to Infrastructure (V2I) communication, and Vehicle to Pedestrian (V2P) communication in Vehicle to Everything (V2X) communication.

In some embodiments, the foregoing wireless communication system may further include a network management device 130.

Several base stations 120 are connected to the network management device 130 respectively. The network management device 130 may be a core network device in a wireless communication system. For example, the network management device 130 may be a mobility management entity (MME) in an Evolved Packet Core (EPC) network.

Alternatively, the network management device may also be other core network devices, such as Serving GateWay (SGW), Public Data Network GateWay (PGW), Policy and Charging Rules Function (PCRF) or Home Subscriber Server (HSS), etc. The implementation form of the network management device 130 is not limited in the embodiments of the present disclosure.

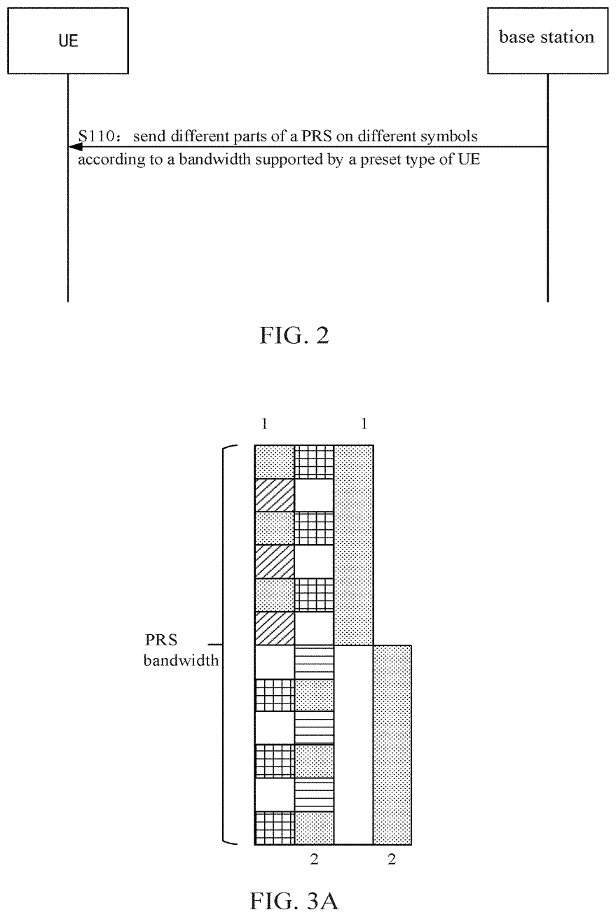

As shown in FIG. 2, the present embodiment provides a method for sending a PRS, and the method includes.

In the S110: different parts of the PRS are sent on different symbols according to a bandwidth supported by a UE of a predetermined type.

The method for sending the PRS provided by the embodiment of the present disclosure may be performed by a base station. The base station may assist the UE to perform its own positioning measurement through the sending of the PRS.

For example, the UE may determine a distance between the UE itself and the base station according to a receiving power of the received PRS.

For another example, an angle between the UE and the base station may also be determined according to a beam direction of a beam sending the PRS, so that the base station may assist the UE to perform its own positioning measurement through the sending of PRS.

In some embodiments, UEs of a predetermined type may be Reduced capability NR devices, which may also be referred to as light UEs for short. The UE of the non-predetermined type may include an eMBB UE.

In an application process, the UE of the predetermined type and the UE of the non-predetermined type may be distinguished by ability of the UEs, for example, by a bandwidth size supported by the UE. A maximum bandwidth supported by the UE of the predetermined type here is less than maximum bandwidths supported by some UE of the non-predetermined type.

A cell formed by the base station may contain the UE of the predetermined type or the UE of the non-predetermined type. The bandwidths supported by the two types of UEs are different. When the base station is performing the PRS sending, if the PRS sending is performed without distinguishing the UE type, to reduce the complexity of the PRS sending caused by the base station distinguishing the UE type of the PRS sending, it is also necessary to ensure the UE of the predetermined type may receive the US and may perform the positioning measurement according to the received PRS.

In the embodiment of the present disclosure, when the base station performs the PRS sending, the base station sends the PRS on different symbols according to the bandwidth supported by the UE of the predetermined type. Thus, different parts of one PRS are located on different symbols. In this way, it is equivalent to dividing the PRS for transmission in a time domain, and the UE may complete the PRS reception on different symbols. In this way, since one PRS is divided into a plurality of symbols for transmission, rather than using a large bandwidth for transmission, even the UE of the predetermined type that supports a small bandwidth may successfully receive the PRS and complete its own positioning measurement. Since one PRS is divided into different symbols for transmission, the transmitted PRS may be received by both the UE of the predetermined type and the UE of the non-predetermined type. In this way, the base station may not distinguish the type when transmitting the PRS, using one transmission manner or in a same PRS configuration, to send the PRS to the UE, which simplifies the complexity of the base station in sending the PRS.

In an embodiment, the S110 may include.

A PRS sequence of the PRS is divided into n parts according to the bandwidth supported by the UE of the predetermined type, wherein n is an integer equal to or greater than 2;

each of the n parts is sent on n symbols, respectively.

The PRS in the embodiment of the present disclosure corresponds to a PRS sequence with a relatively large length. In the embodiment of the present disclosure, in order to transmit the different parts of the PRS by using different symbols, the PRS sequence is divided into n parts, and the different parts is placed on the different symbols for transmission. In this manner, the method has a characteristic of simple implementation.

In some embodiments, the PRS sequence is equally divided into n parts, so that lengths of sub sequences, corresponding to each part, of the PRS sequence are equal.

In some embodiments, the PRS sequence is divided sequentially from front to back according to a sequence, so that different sequence elements of the sub sequence loaded on a same symbol are adjacent in an original PRS sequence. If the PRS sequence includes 2P sequence elements and n equals 2, a first to a P^{th} sequence elements are placed on one symbol for transmission, and a P+1^{th} to a 2P^{th} sequence elements are placed on another symbol for transmission. P is an arbitrary natural number.

When the PRS sequence is divided into n parts, an interval sampling manner may be adopted to divide the PRS sequence into a plurality of different sequences. For example, if n is equal to 2 and the PRS sequence is divided by using the interval sampling, a 2m^{th} sequence element in the PRS sequence may be placed on one symbol for transmission, and a 2m+1^{th} sequence element in the PRS sequence may be placed on another symbol for transmission. M is an arbitrary natural number.

Of course, the above is a simple and convenient optional manner of dividing and transmitting the PRS on different symbols in the time domain, and a specific implementation is not limited to this.

In some embodiments, the sending the each of the n parts on the n symbols respectively includes.

The each of the n parts is sent on the n symbols through frequency hopping;

or,

the each of the n parts is sent on the n symbols in a same frequency band.

When the n symbols are used to transmit each of the n parts, the frequency hopping transmission may be used for transmission, or the same frequency band (i.e., non-frequency hopping transmission) may be used for transmission. For example, the frequency hopping is used to transmit the different parts on the n symbols, and adjacent parts of the n parts are located on different frequency bands, so that the terminal may have diversity gain in a frequency domain.

For example, the n parts may be transmitted on two frequency bands through the frequency hopping, and for adjacent three parts, two of the adjacent three parts are located on the same frequency band.

Of course, in order to simplify the transmission and UE reception, the n parts may be transmitted on the n symbols in the same frequency band.

In some embodiments, parts, carried by adjacent two symbols, in the n parts sent through the frequency hopping are located on different frequency bands.

In some embodiments, the frequency bands where the n parts are sent through the frequency hopping are continuous in a frequency domain.

The n parts sent through the frequency hopping may be continuous or discontinuous in the frequency domain. In order to simplify the demodulation on a UE side, the n parts sent through the frequency hopping may be continuous on the frequency band, so that when the UE receives through the frequency hopping, between receptions of the adjacent two parts, a frequency band that needs to be cross is reduced, which reduces hardware and software requirements of the UE for the PRS reception.

In some embodiments, a modulation phase of a last modulation signal at a former part in adjacent two parts of the n parts and a modulation phase of an initial modulation signal of a latter part in the adjacent two parts are adjacent in a phase sequence of modulation phases.

After the PRS sequence is modulated, a carrier phase corresponding to the modulation signal formed by each sequence element has a plurality of alternative modulation phases. These alternative modulation phases are arranged in sequence to form a phase sequence.

Assuming that one quadrature amplitude modulation signal is represented by one complex number, and the complex number includes a real part and an imaginary part. In the phase sequence, angles of complex numbers corresponding to adjacent two alternative modulation phases in a complex number domain are different, and the angle may be expressed as the modulation phase. Thus, in the embodiment of the present disclosure, the modulation signals of the adjacent two parts need to meet the requirement that order of the modulation phase, of the last modulation signal at the former part in the adjacent two parts, and the modulation phase, of the initial modulation signal of the latter part, is continuous in the phase sequence, which does not mean that there is no interval between the two phases in a coordinate system; rather, the order of the modulation phases after the signal is converted in the phase sequence is adjacent.

In the embodiment of the present disclosure, through the continuous phase arrangement, the combination and demodulation are much easier after the UE receives the different parts. Meanwhile, through this modulation manner, an error rate of the demodulation may be reduced and a success rate of the demodulation may be improved.

In some embodiments, the S110 may include. The different parts of the PRS are sent on a plurality of symbols that are continuous in a time domain according to the bandwidth supported by the UE of the predetermined type.

The demodulation of UE may be simplified by sending the different parts of the PRS on the plurality of symbols distributed continuously in the time domain. For example, the n symbols transmitting different parts of the PRS may be distributed continuously or discretely in the time domain.

In the embodiment of the present disclosure, on one hand, in order to reduce the transmission delay of the PRS, and on the other hand, to simplify the decoding and demodulation of the PRS by the UE, the plurality of symbols may be continuously distributed in the time domain.

In other embodiments, in order to improve an effective utilization rate of time-frequency resource in the communication system, scattered communication resource is fully utilized, or when time-domain resource in the communication system is tight, the n symbols may also be distributed discretely.

It should be noted that resource locations of the n symbols may be statically configured, semi-statically configured, or dynamically configured.

The base station may choose a manner to perform a resource configuration of the n symbols according to load of the base station and an idle rate of the resource. For example, when the n symbols are dynamically configured, resource information of the n symbols may be transmitted through downlink control information (DCI). The resource information indicates resource locations of at least n symbols.

In a word, in order to improve the transmission efficiency of the PRS and simplify the decoding and demodulation of the UE, the continuity of the n symbols in the time domain may be improved as much as possible. For example, if n is equal to 4, a discrete distribution of all four symbols may be more continuous than a continuous distribution of three symbols and a discrete distribution of one symbol with the other three symbols.

In some embodiments, the PRS has a repeated configuration, wherein the repeated configuration includes a time domain repeated configuration for repeatedly sending a symbol of the PRS in a time domain, or a frequency domain repeated configuration for repeatedly sending a symbol of the PRS in a frequency domain.

In the embodiment of the present disclosure, in order to improve diversity gain of the UE for the PRS reception, the base station repeatedly configures the sending of the PRS, so as to ensure the receiving power of the UE to the PRS through retransmission of the PRS. For example, the PRS is repeatedly sent in the time domain or the PRS is repeated in the frequency domain.

The PRS is repeatedly sent in the frequency domain. Thus, the frequency domain resources used for the repeated sending may be the same or different.

In a word, if the PRS has the repeated configuration, one positioning measurement of the UE receives multiple times of sendings of the same PRS, thus improving the success rate of the reception.

If the modulation signals of the n parts of the PRS sequence have modulation signal continuity, the PRS may or may not have the repeated configuration. Whether the base station sends the PRS repeatedly may be determined according to a current load rate of the base station, which is not limited here.

In some embodiments, the PRS has the repeated configuration when modulation signals of the n parts of the PRS sequence do not have phase continuity.

In order to ensure a reception quality of the PRS, when the modulation symbols corresponding to the n parts of the PRS sequence do not have the phase continuity, the PRS may be repeatedly configured to ensure the reception quality of the PRS by repeatedly sending the PRS.

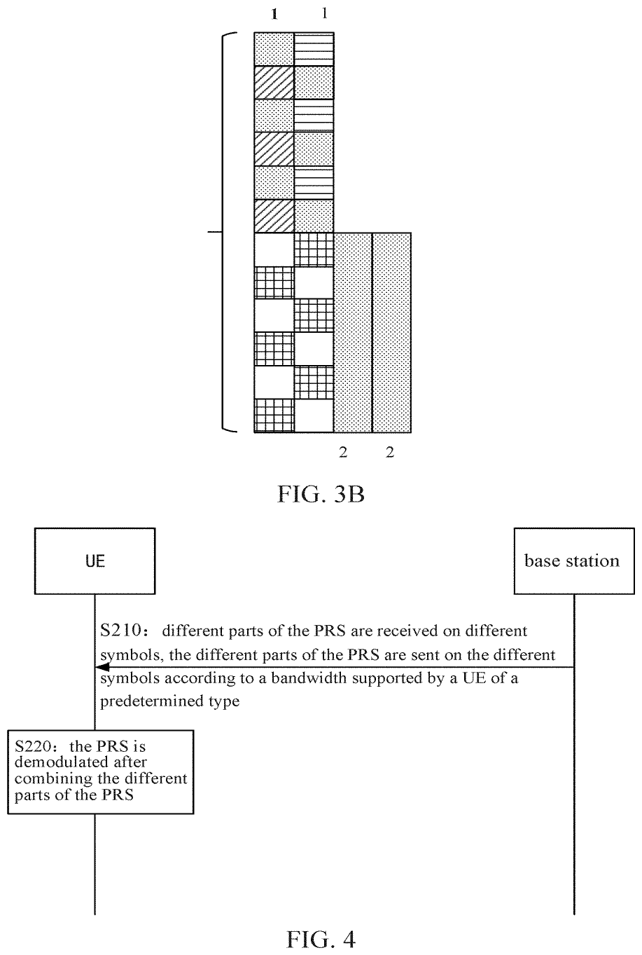

As shown in FIG. 3A and FIG. 3B, an original PRS bandwidth for sending the PRS is one RE, while the time domain resource for sending the PRS bandwidth is two symbols. Considering the bandwidth supported by the UE of the predetermined type, the PRS bandwidth is truncated to ½ RE, and for the time domain resource, is sent on four symbols. In FIG. 3A and FIG. 3B, a reference number 1 may be considered as a first part of the PRS, and a reference number 2 may be considered as a second part of the PRS. It may be seen from FIG. 3A and FIG. 3B, the first part of the PRS may be in the same frequency band, while different parts of the PRS are in different frequency bands. In addition, the same part of the PRS may be sent continuously or discontinuously in the time domain. For example, in FIG. 3A, the same part of the PRS is sent using discrete symbols in the time domain. In FIG. 3B, the same part of the PRS is sent using symbols distributed continuously in the time domain.

As shown in the drawings, embodiments of the present disclosure provide a method for receiving a position reference signal PRS, and the method includes.

In the S210: different parts of the PRS are received on different symbols, the different parts of the PRS are sent on the different symbols according to a bandwidth supported by a UE of a predetermined type;

in the S220: the PRS is demodulated after combining the different parts of the PRS.

The method for receiving the PRS provided by the embodiments of the present disclosure is performed by various types of UEs, for example, a UE of a predetermined type and a UE of a non-predetermined type.

Since the different parts of the PRS are divided into the different symbols for transmission, firstly, after the UE receives the PRS on each symbol, the combination needs to be performed, and then the PRS is demodulated after the combination. Since the different parts of the PRS in the present disclosure are transmitted on different symbols, a bandwidth occupied by the PRS on a single symbol is less than or equal to a bandwidth supported by the UE of the predetermined type, thus ensuring that the UE that only supports a small bandwidth may successfully receive the PRS. Moreover, due to this sending manner of the PRS, the PRS of the UE of the non-predetermined type supporting a large bandwidth and the PRS of the UE of the predetermined type may be sent in the same manner, and thus, the manner for the base station to send the PRS may be greatly simplified.

It should be noted that, since the manner for the base station to divide the PRS is different, and a corresponding manner for the UE side to combine and receive the PRS is also different. The base station and the UE may negotiate the manner for dividing the PRS in advance, so as to ensure that the UE side may successfully demodulate the PRS.

In some embodiments, the dividing manner of the PRS (i.e., the corresponding combining method) may be specified in a communication protocol.

In some embodiments, the S210 may include.

Each of the n parts is received on n symbols, respectively; a PRS sequence of the PRS is divided into n parts, and different parts of the n parts are located on different symbols.

The UE receives different parts of the PRS on different symbols, and the different parts correspond to different parts of the PRS sequence.

In some embodiments, the S210 may include.

The each of the n parts is received on the n symbols through frequency hopping;

or,

the each of the n parts is received on the n symbols in a same frequency band.

In the embodiment of the present disclosure, the base station may transmit the each of the n parts through frequency hopping, and may transmit the each part in the same frequency band.

If the base station transmits the n parts through frequency hopping, the UE needs to receive the each part of the n parts through frequency hopping according to a frequency hopping sequence.

The frequency hopping sequence may be informed by the base station to the UE in advance, or may be specified in the communication protocol.

If the base station sends each of the n parts on n symbols in the same frequency band, the UE may receive the n parts on the n symbols in the same frequency band without frequency hopping.

In some embodiments, parts, carried by adjacent two symbols, in the n parts sent through the frequency hopping are located on different frequency bands.

In one case, during the frequency hopping transmission, the n parts may be transmitted on at least two frequency bands, and adjacent parts may be transmitted on the same frequency band or different frequency bands.

In the embodiment of the present disclosure, in order to further improve the frequency domain reception gain, the adjacent parts are received on different frequency bands.

In some embodiments, the frequency bands where the n parts are sent through the frequency hopping are continuous in a frequency domain.

In some embodiments, the frequency hopping sequence and the PRS sequence of the PRS have a preset correspondence. In this way, the UE may determine a decoded PRS sequence according to the preset correspondence after receiving the PRS, and decode the received PRS, so that the UE may complete the positioning measurement according to a parameter that may reflect a transmission loss, such as a receiving power of the PRS, in a case of ensuring the correct PR reception.

In order to simplify the reception of the UE, the frequency bands used by the adjacent two parts that are transmitted by the frequency hopping may be continuous in the frequency domain. In this way, the UE may perform the frequency hopping reception without crossing a large frequency band during the frequency hopping reception.

In some embodiments, a modulation phase of a last modulation signal at a former part in adjacent two parts of the n parts and a modulation phase of an initial modulation signal of a latter part in the adjacent two parts are adjacent in a phase sequence of modulation phases.

The phase here meeting the condition may ensure a success rate of demodulation.

In some embodiments, the PRS has a repeated configuration, wherein the repeated configuration includes a time domain repeated configuration for repeatedly sending a symbol of the PRS in a time domain, or a frequency domain repeated configuration for repeatedly sending a symbol of the PRS in a frequency domain.

For example, the PRS has the repeated configuration when modulation signals of the n parts of the PRS sequence do not have phase continuity.

If the PRS has the repeated configuration, the UE repeatedly receives the PRS according to the repeated configuration to improve the receiving power of the PRS.

In some embodiments, S210 may include. The different parts of the PRS are received on a plurality of symbols that are continuously distributed in the time domain.

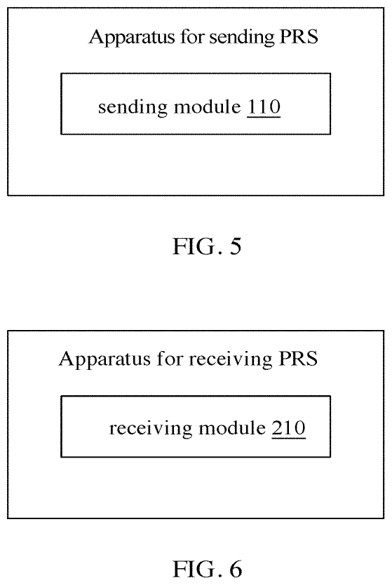

As shown in FIG. 5, embodiments provide an apparatus for sending the PRS, the apparatus includes:

a sending module 110, configured to different parts of the PRS on different symbols according to a bandwidth supported by a UE of a predetermined type.

The apparatus may be performed by a base station.

In some embodiments, the sending module 110 may be a program module, and after the program module is executed by a processor, different parts of the PRS may be sent on different symbols.

In some other embodiments, the sending module 110 may be a combination module of hardware and software. The combination module of hardware and software includes, but is not limited to: a programmable array, and the programmable array includes, but is not limited to, a complex programmable array or a field programmable array.

In yet some other embodiments, the sending module 110 also includes: a pure hardware module, and the pure hardware module includes, but is not limited to: application specific integrated circuit.

In some embodiments, the sending module 110 is configured to divide a PRS sequence of the PRS into n parts according to the bandwidth supported by the UE of the predetermined type, n is an integer equal to or greater than 2; each of the n parts is sent on n symbols respectively.

In some embodiments, the sending module 110 is configured to send the each of the n parts on the n symbols through frequency hopping, or, the each of the n parts is sent on the n symbols in a same frequency band.

In some embodiments, parts, carried by adjacent two symbols, in the n parts sent through the frequency hopping are located on different frequency bands.

In some embodiments, the frequency bands where the n parts are sent through the frequency hopping are continuous in a frequency domain.

In some embodiments, a modulation phase of a last modulation signal at a former part in adjacent two parts of the n parts and a modulation phase of an initial modulation signal of a latter part in the adjacent two parts are adjacent in a phase sequence of modulation phases.

In some embodiments, the PRS has a repeated configuration, wherein the repeated configuration includes a time domain repeated configuration for repeatedly sending a symbol of the PRS in a time domain, or a frequency domain repeated configuration for repeatedly sending a symbol of the PRS in a frequency domain.

In some embodiments, the PRS has the repeated configuration when modulation signals of the n parts of the PRS sequence do not have phase continuity.

In some embodiments, the sending module 110 is configured to send the different parts of the PRS on a plurality of symbols that a continuous in a time domain according to the bandwidth supported by the UE of the predetermined type.

As shown in FIG. 6, embodiments of the present disclosure further provide an apparatus for receiving the PRS, and the apparatus includes:

a receiving module 210, configured to different parts of the PRS on different symbols, the different parts of the PRS are sent on different symbols, and are determined according to a bandwidth supported by a UE of a predetermined type;

a demodulation module, configured to demodulate the PRS after combining the different parts of the PRS.

In some embodiments, the receiving module 210 and the demodulation module may be program modules. After the program modules are executed by a processor, different parts of the PRS may be received on different symbols, and the PRS may be combined and demodulated.

In other embodiments, the receiving module 210 and the demodulation module may be a combination of hardware and software. The combination of hardware and software includes but is not limited to: a programmable array, and the programmable array includes, but is not limited to, a complex programmable array or a field programmable array.

In other embodiments, the receiving module 210 and the demodulation module also include: a pure hardware module, and the pure hardware module includes, but is not limited to: application special integrated circuit.

In some embodiments, the receiving module 210 is configured to receive the each of the n parts on n symbols respectively, a PRS sequence of the PRS is divided into the n parts, and different parts of the n parts are located on the different symbols.

The receiving module 210 is configured to receive the each of the n parts on the n symbols through frequency hopping; or, the each of the n parts is received on n symbols in a same frequency band.

In some embodiments, the parts, carried by adjacent two symbols, in the n parts sent through the frequency hopping are located on different frequency bands.

In some embodiments, the frequency bands where the n parts sent through the frequency hopping are continuous in a frequency domain.

In some embodiments, a modulation phase of a last modulation signal at a former part in adjacent two parts of the n parts and a modulation phase of an initial modulation signal of a latter part in the adjacent two parts are adjacent in a phase sequence of modulation phases.

In some embodiments, the PRS has a repeated configuration, wherein the repeated configuration includes a time domain repeated configuration for repeatedly sending a symbol of the PRS in a time domain, or a frequency domain repeated configuration for repeatedly sending a symbol of the PRS in a frequency domain.

In some embodiments, the PRS has the repeated configuration when modulation signals of the n parts of the PRS sequence do not have phase continuity.

Embodiments of the present disclosure also provide a method for transmitting a PRS, and the method includes.

The PRS is sent according to a type of the UE, and different types of the UEs send the PRS in different manners.

For example, for the above UE of the predetermined type, the PRS is repeatedly sent on a first bandwidth, while for the UE of the non-predetermined type which supports a bandwidth larger than a bandwidth of the UE of the predetermined type, the PRS is sent on a second bandwidth. The second bandwidth is greater than the first bandwidth.

In some embodiments, the first bandwidth is less than or equal to the bandwidth supported by the UE of the predetermined type.

The second bandwidth is larger than the bandwidth supported by the UE of the predetermined type, and is less than or equal to the bandwidth supported by the UE of the non-predetermined type.

In some embodiments, the second bandwidth is more than 2 times the first bandwidth.

In some embodiments, a number of first time domain resources occupied by the PRS of the UE of the predetermined type is greater than a number of second time domain resources occupied by the PRS of the UE of the non-predetermined type.

In some other embodiments, a total number of communication resources corresponding to the first bandwidth and the first time domain resources may be the same as a total number of communication resources corresponding to the second bandwidth and the second time domain resources.

In some embodiments, the second bandwidth is 2 times the first bandwidth. A number of the second time domain resources is ½ a number of the first time domain resources.

Of course, in some other embodiments, the first bandwidth may also be ¾ of the second bandwidth.

Time domain units corresponding to the number of the second time domain resources are distributed discretely in the time domain, while time domain units corresponding to the number of the first time domain resources are continuously distributed in the time domain. The time domain units herein include, but are not limited to, symbols or mini-slots. Such a discrete distribution may cause the time domain units to be at intervals by the number of the second time domain resources.

For example, the time domain units are symbols, and the number of the second time domain resources is 2, the number of the first time domain resources is 4. Thus, the interval between the two symbols corresponding to the number of the second time domain resources is at least two symbols. In this way, for the PRS transmission of different types of UEs, the transmission may be performed using the same resource pool. In this way, the different types of UEs may share the same resource pool for transmitting the PRS.

In some cases, the UE of the predetermined type includes, but is not limited to: an enhance Mobile Broadband (eMBB) UE.

For example, for the PRS transmission of the eMBB UE, the transmission is performed on two symbols of one resource element (RE), while for the PRS transmission of a Redcap UE, the transmission is performed on four symbols on a half of the RE.

The PRS transmission here includes the PRS sending of the base station and/or the PRS reception of the UE.

In the embodiment of the present disclosure, the base station and the UE transmit the PRS in different manner for the different types of the UEs, realizing the PRS decoupling for the different types of UEs, thus ensuring that each UE may receive the PRS suitable for its own positioning measurement and realizing the positioning measurement.

Several specific examples are provided below in combination with any of the above embodiments.

### Example 1

For devices with sensors, video surveillance and wearable devices in application scenarios, the bandwidth requirements of the above devices are usually low, 20-40 M, or even 10 M. Take a Redcap UE supporting 20 M bandwidth as an example.

A PRS is a downlink signal sent by a base station in a 3GPP NR air interface for positioning. It is well known that a bandwidth of the positioning is proportionate to an accuracy, and a bandwidth of the PRS ranges from a minimum of 24 Physical Resource Blocks (PRBs) to a maximum of 272 PRBs. Generally, the base station may select an appropriate bandwidth according to a positioning accuracy requirement and the system resource, for example, 96 PRBs, SCS=30 KHz, about 35 M, and a minimum configuration of two continuous time domain symbols.

If the accuracy needs to be improved, a larger bandwidth or more time domain symbols are configured, or both (an expansion accuracy of the frequency domain bandwidth is higher than that of the time domain repeat). However, for the Redcap UE limited to the bandwidth of the UE, only the bandwidth of the PRS with a maximum bandwidth supported by the UE can be configured at the same time, such as 20 M, so the accuracy drops a lot. In order to ensure that the Redcap UE may achieve a higher positioning accuracy under certain requirements, the PRS configuration needs to be compatible with the Redcap UE and save resources as much as possible.

Two symbols of a normal UE (that is, a supported bandwidth is greater than the redcap UE) may be configured at an interval of RE. Since the bandwidth of the Redcap UE is exceeded, a basic and easy-to-think method for configuring the Redcap UE is to repeat a small bandwidth of four symbols. However, such positioning accuracy and a large bandwidth ratio are not enough. Here is an example of 2 times, or ¾ times the bandwidth.

### Example 2

For a PRS sequence with a bandwidth of n, a base station configures it to the Redcap UE in a cross-symbol frequency hopping manner, that is, a first part of the sequence is configured on a first symbol, a second part is configured to an adjacent different bandwidth of a second symbol, and so on for a third symbol (if the bandwidth exceeds 2 times).

The PRS sequence of the PRS is divided into n parts in configuration. For example, there are two parts in the drawing, and a first part is sent on a first symbol in a first frequency domain, and a second part is sent on a second symbol in a second frequency domain, and so on for a third and a fourth symbols.

Another solution is that the first part is sent on a first symbol in a first frequency domain, a second part is sent on a third symbol in a second frequency domain, and a second part is sent on a second symbol in the first frequency domain, as shown in the second part of the drawing.

The base station side ensures that a first part . . . a n^{th} part of the n parts are continuous in the frequency domain, and ensures that the phases of the modulation phases are continuous. The above two configurations implicitly ensure the phase continuity.

The base station may not be configured with the phase continuity, but may be configured through method of multiple time domain repeats. The base station may also be configured through frequency hopping repeats without configuring the phase continuity.

UE side: The UE receives the PRS according to the PRS configuration of the base station, and performs the combination of the different parts and the demodulation.

Embodiments of the present disclosure provide a communication device, including a processor, a transceiver, a memory, and an executable program stored on the memory and capable of being run by the processor. When the processor executes the executable program, the control channel detection method, performed by the UE, provided in any one of the above technical solutions, or the method for processing information, performed by the base station, provided in any one of the above technical solutions, are executed.

The communication device may be the base station or the UE that are mentioned above.

The processor may include various types of storage medium, the storage medium is non-transitory computer storage medium capable of continuing to store the information stored thereon after the communication device is powered off. Here, the communication device includes a base station or user equipment.

The processor may be connected to the memory through a bus or the like, and is configured to read executable programs stored on the memory, for example, through the method illustrated in FIG. 2 and/or FIG. 4.

Embodiments of the present disclosure provide a computer storage medium, the computer storage medium stores a computer executable program, and when the computer executable program is executed by a processor, the method described in any one of the technical solutions of the first aspect and second aspect is implemented, for example, at least one of the method illustrated in FIGS. 2 to 6.

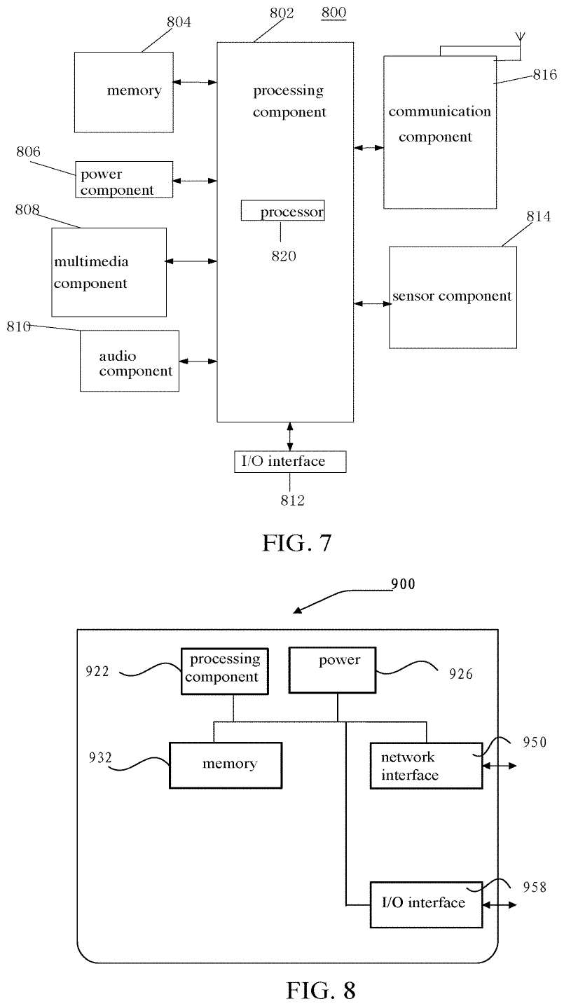

FIG. 7 is a block diagram of a UE 800 according to an exemplary embodiment. For example, the UE 800 may be a mobile phone, a computer, digital broadcast device, messaging device, a gaming console, tablet device, medical device, exercise device, a personal digital assistant, and the like.

Referring to FIG. 7, the UE 800 may include at least one of a processing component 802, memory 804, a power component 806, a multimedia component 808, an audio component 810, an input/output (I/O) interface 812, a sensor component 814, a communication component 816, and the like.

The processing component 802 may generally control an overall operation of the UE 800, such as operations associated with display, a telephone call, data communication, a camera operation, a recording operation, etc. The processing component 802 may include at least one of processors 820 to execute instructions so as to complete all or a part of steps of the aforementioned method. In addition, the processing component 802 may include at least one of modules to facilitate interaction between the processing component 802 and other components. For example, the processing component 802 may include a multimedia portion to facilitate interaction between the multimedia component 808 and the processing component 802.

The memory 804 may be configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, at least one of power sources, and any other components associated with the generation, management, and distribution of power for the UE 800.

The multimedia component 808 may include a display screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes at least one of touch sensors to sense touches, swipes, and gestures on the touch panel. The touch sensors may not only sense a boundary of a touch or swipe action, but also sense a wake time and a pressure associated with the touch or swipe action. In some embodiments, the multimedia component 808 includes a front camera and/or a rear camera. The front camera and the rear camera may receive an external multimedia data while the UE 800 is in an operation mode, such as a photographing mode or a video mode. Each of the front camera and the rear camera may be a fixed optical lens system or have optical focusing and zooming capability.

The audio component 810 may be configured to output and/or input audio signals. For example, the audio component 810 may include a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, the peripheral interface modules being, for example, a keyboard, a click wheel, buttons, and the like. The buttons may include, but are not limited to, a home button, a volume button, a starting button, and a locking button.

The sensor component 814 includes at least one of sensors to provide status assessments of various aspects of the UE 800. For instance, the sensor component 814 may detect an open/closed status of the UE 800, relative positioning of components (e.g., the display and the keypad, of the UE 800), a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor or thermometer.

The communication component 816 may be configured to facilitate communication, wired or wirelessly, between the UE 800 and other devices. The UE 800 can access a wireless network based on a communication standard, such as WiFi, 2G, 3G, LTE, or 4G cellular technologies, or a combination thereof. In an exemplary embodiment, the communication component 816 receives a broadcast signal or broadcast associated information from an external broadcast management system via a broadcast channel. In an exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 800 may be implemented with at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described method.

In exemplary embodiments, there is also provided a non-transitory computer-readable storage medium including instructions, such as included in the memory 804, executable by the processor 820 in the at least one of UE 800, for performing the above-described methods. For example, the non-transitory computer-readable storage medium may be a Read-Only Memory (ROM), Random Access Memory (RAM), Compact Disc Read-Only Memory (CD-ROM), a magnetic tape, a floppy disk, optical data storage device, and the like.

As illustrated in FIG. 8, a structure of a base station is shown according to embodiments of the disclosure. For example, the base station 900 may be provided as a network device. As illustrated in FIG. 8, the base station 900 includes a processing component 922. The processing component 922 further includes at least one of processors, and a memory resource represented by a memory 932, for storing instructions that can be executed by the processing component 922, such as application programs. The application programs stored in the memory 932 may include one or more modules each corresponding to a set of instructions. In addition, the processing component 922 is configured to execute any of the above methods performed by the base station as described above, such as the method illustrated in FIG. 2 and/or FIG. 4.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™ or the like.

Other embodiments of the present disclosure will readily occur to those skilled in the art upon consideration of the specification and practice of embodiments disclosed herein. The present disclosure is intended to cover any variations, uses, or adaptations of the disclosure that follow the general principles of the present disclosure and include common general knowledge or techniques in the technical field not disclosed by the disclosure. The specification and examples are to be regarded as exemplary only, with the true scope and spirit of the disclosure being indicated by the appended claims.

It should be understood that the present disclosure is not limited to the precise structures described above and illustrated in the accompanying drawings, and that various modifications and changes may be made without departing from the scope thereof. The scope of the present disclosure is limited only by the appended claims.

1. A method for sending a position reference signal (PRS), performed by a base station, comprising:
sending different parts of the PRS on different symbols according to a bandwidth supported by a UE of a predetermined type.

2. The method according to claim 1, wherein the sending the different parts of the PRS on the different symbols according to the bandwidth supported by the UE of the predetermined type comprises:
dividing a PRS sequence of the PRS into n parts according to the bandwidth supported by the UE of the predetermined type, wherein n is an integer equal to or greater than 2;
sending the n parts on n symbols, respectively.

3. The method according to claim 2, wherein the sending the n parts on the n symbols respectively comprises:
sending the n parts on the n symbols through frequency hopping; or,
sending the n parts on the n symbols in a same frequency band.

4. The method according to claim 3, wherein parts, carried by adjacent two symbols, in the n parts sent through the frequency hopping are located on different frequency bands.

5. The method according to claim 4, wherein the frequency bands where the n parts are sent through the frequency hopping are continuous in a frequency domain.

6. The method according to claim 2, wherein
a modulation phase of a last modulation signal at a former part in adjacent two parts of the n parts and a modulation phase of an initial modulation signal of a latter part in the adjacent two parts are adjacent in a phase sequence of modulation phases.

7. The method according to claim 2, wherein the PRS has a repeated configuration, wherein the repeated configuration comprises a time domain repeated configuration for repeatedly sending of the PRS in a time domain, or a frequency domain repeated configuration for repeatedly sending a the PRS in a frequency domain.

8. The method according to claim 7, wherein the PRS has the repeated configuration and modulation signals of the n parts of the PRS sequence do not have phase continuity.

9. The method according to claim 1, wherein the sending the different parts of the PRS on the different symbols according to the bandwidth supported by the UE of the predetermined type comprises:
sending the different parts of the PRS on a plurality of symbols that are continuous in a time domain according to the bandwidth supported by the UE of the predetermined type.

10. A method for receiving a position reference signal (PRS), performed by a UE, comprising:
receiving different parts of the PRS on different symbols, wherein the different parts of the PRS are sent on the different symbols according to a bandwidth supported by a UE of a predetermined type;
demodulating the PRS after combining the different parts of the PRS.

11. The method according to claim 10, wherein the receiving the different parts of the PRS on the different symbols comprises:
receiving n parts on n symbols, respectively; wherein a PRS sequence of the PRS is divided into then parts, and different parts of the n parts are located on the different symbols.

12. The method according to claim 11, wherein the receiving the n parts on the n symbols respectively comprises:
receiving the n parts on the n symbols through frequency hopping; or,
receiving the n parts on the n symbols in a same frequency band.

13. The method according to claim 12, wherein parts, carried by adjacent two symbols, in the n parts received through the frequency hopping are located on different frequency bands.

14. The method according to claim 13, wherein the frequency bands where the n parts are received through the frequency hopping are continuous in a frequency domain.

15. The method according to claim 11, wherein,
a modulation phase of a last modulation signal at a former part in adjacent two parts of the n parts and a modulation phase of an initial modulation signal of a latter part in the adjacent two parts are adjacent in a phase sequence of modulation phases.

16. The method according to claim 11, wherein the PRS has a repeated configuration, wherein the repeated configuration comprises a time domain repeated configuration for repeatedly sending of the PRS in a time domain, or a frequency domain repeated configuration for repeatedly sending the PRS in a frequency domain.

17. The method according to claim 16, wherein the PRS has the repeated configuration, modulation signals of the n parts of the PRS sequence do not have phase continuity.

18-19. (canceled)

20. A communication device comprising a processor, a transceiver, a memory and an executable program stored on the memory and capable of being run by the processor, wherein the processor executes a method for sending a position reference signal (PRS) when running the executable program, the method is performed by a base station and comprises:
sending different parts of the PRS on different symbols according to a bandwidth supported by a UE of a predetermined type.

21. (canceled)

22. The communication device according to claim 20, wherein the sending the different parts of the PRS on the different symbols according to the bandwidth supported by the UE of the predetermined type comprises:
dividing a PRS sequence of the PRS into n parts according to the bandwidth supported by the UE of the predetermined type, wherein n is an integer equal to or greater than 2;
sending the n parts on n symbols respectively.

23. A communication device comprising a processor, a transceiver, a memory and an executable program stored on the memory and capable of being nm by the processor, wherein the processor executes the method according to claim 10.
